(19) United States
(12) Patent Application Publication
(10) Pub. No.: US 2024/0300765 A1
(43) Pub. Date: Sep. 12, 2024

(54) SHEET CONVEYANCE DEVICE AND IMAGE FORMING APPARATUS

(71) Applicant: KYOCERA Document Solutions Inc., Osaka (JP)

(72) Inventor: Takuro MORITA, Osaka (JP)

(73) Assignee: KYOCERA Document Solutions Inc., Osaka (JP)

(21) Appl. No.: 18/593,027

(22) Filed: Mar. 1, 2024

(30) Foreign Application Priority Data
Mar. 8, 2023 (JP) 2023-035302

(51) Int. Cl. B65H 29/58; G03G 15/01

(52) U.S. Cl. CPC B65H 29/58; G03G 15/0105; G03G 15/0189; B65H 2301/341; B65H 2404/69

(57) ABSTRACT

A sheet conveyance device includes a reversing conveyance portion and a conveyance guide member. A sheet from a sheet reversing portion travels into and out of the reversing conveyance portion to be switched back so that the conveyance direction of the sheet is switched. The conveyance guide member is provided in the reversing conveyance portion, and has a sheet conveyance face facing the bottom face of the sheet passing through the reversing conveyance portion. The sheet conveyance face has one or more curved portions curved in the up-down direction as viewed from the width direction orthogonal to the conveyance direction of the sheet, and curves the sheet along the curved portion.

### INCORPORATION BY REFERENCE

This application is based on and claims the benefit of priority from Japanese Patent Application No. 2023-035302 filed on Mar. 8, 2023, the contents of which are hereby incorporated by reference.

### BACKGROUND

The present disclosure relates to sheet conveyance devices and image forming apparatuses.

Image forming apparatuses such as copiers are provided with, for duplex printing, a reversing conveyance passage for switching back a sheet, which is a recording medium on which an image is formed, to switch the conveyance direction of the sheet.

### SUMMARY

According to one aspect of the present disclosure, a sheet conveyance device includes a reversing conveyance portion and a conveyance guide member. A sheet from a sheet reversing portion travels into and out of the reversing conveyance portion to be switched back so that the conveyance direction of the sheet is switched. The conveyance guide member is provided in the reversing conveyance portion, and has a sheet conveyance face facing the bottom face of the sheet passing through the reversing conveyance portion. The sheet conveyance face has one or more curved portions curved in the up-down direction as viewed from the width direction orthogonal to the conveyance direction of the sheet, and curves the sheet along the curved portion.

### BRIEF DESCRIPTION OF THE DRAWINGS

FIG. 1 is a schematic sectional front view of an image forming apparatus according to an embodiment of the present disclosure.

FIG. 2 is a sectional front view around a sheet conveyance device in the image forming apparatus in FIG. 1.

### DETAILED DESCRIPTION

Hereinafter, an embodiment of the present disclosure will be described with reference to the drawings. The present disclosure is not limited to what is specifically described below.

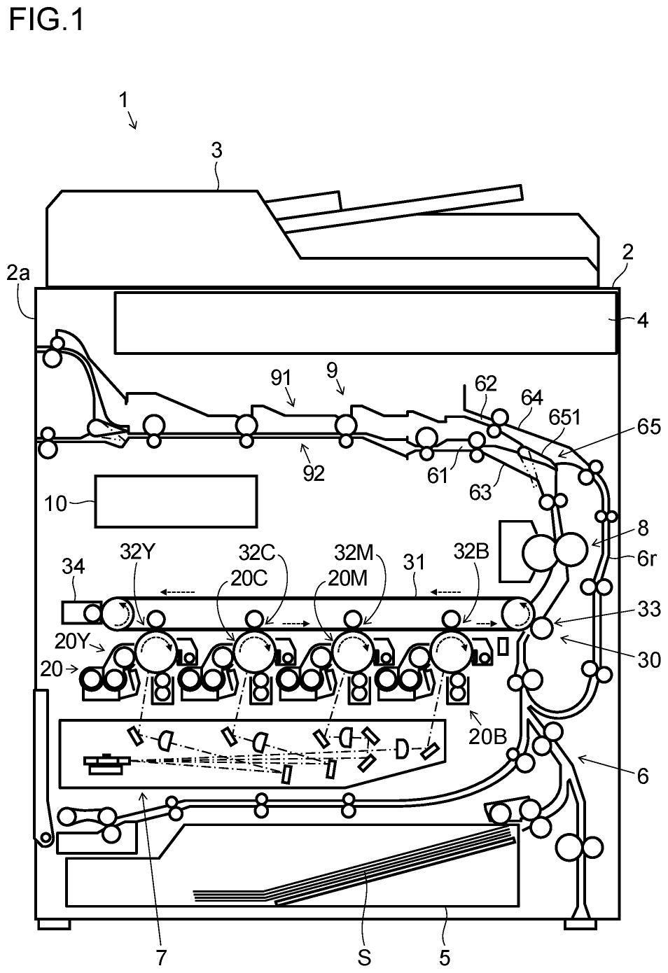

FIG. 1 is a schematic sectional front view of an image forming apparatus 1 according to an embodiment. One example of the image forming apparatus 1 according to the present embodiment is a tandem-type color printer that transfers a toner image to a sheet S using an intermediate transfer belt 31. The image forming apparatus 1 may be, for example, what is called a multifunction peripheral that has functions such as printing, scanning (image reading), and facsimile transmission.

As shown in FIG. 1, the image forming apparatus 1 includes a document conveyance portion 3 placed on the top face of its main body 2 and an image reading portion 4 arranged inside the main body 2, below the document conveyance portion 3. The document conveyance portion 3 conveys stacked document sheets toward the image reading portion 4. The image reading portion 4 reads an image on a document conveyed by the document conveyance portion 3 and an image on a document placed on a contact glass (not illustrated) on the top face of the image reading portion 4.

The image forming apparatus 1 further includes, in the main body 2, a sheet feeding portion 5, a sheet conveyance portion 6, an exposure portion 7, an image forming portion 20, a transfer portion 30, a fixing portion 8, a sheet conveyance device 9, and a control portion 10.

The sheet feeding portion 5 is arranged at the bottom of the main body 2. The sheet feeding portion 5 accommodates a plurality of sheets S before printing and feeds out the sheets S one by one during printing. The sheet conveyance portion 6 extends along a side wall of the main body 2 in the up-down direction. The sheet conveyance portion 6 conveys the sheet S fed out from the sheet feeding portion 5 to a secondary transfer portion 33 and then to the fixing portion 8. The sheet conveyance portion 6 has a reversing conveyance passage 6r to which a sheet S is conveyed in duplex printing.

The exposure portion 7 is arranged above the sheet feeding portion 5. The exposure portion 7 irradiates the image forming portion 20 with laser light controlled based on image data.

The image forming portion 20 is arranged above the exposure portion 7, below the intermediate transfer belt 31. The image forming portion 20 includes an image forming portion 20Y for yellow, an image forming portion 20C for cyan, an image forming portion 20M for magenta, and an image forming portion 20B for black. The four image forming portions 20 have a similar basic configuration. Accordingly, unless necessary, the suffixes “Y”, “C”, “M”, and “B” for distinction may be omitted in the following description.

The image forming portion 20 includes a photosensitive drum that is supported so as to be rotatable in the predetermined direction (clockwise in FIG. 1). The image forming portion 20 further includes, arranged around the photosensitive drum along its rotation direction, a charging portion, a developing portion, and a drum cleaning portion. A primary transfer portion 32 is arranged between the developing portion and the drum cleaning portion.

The photosensitive drum includes a photosensitive layer on its outer circumferential surface. The charging portion electrostatically charges the outer circumferential surface of the photosensitive drum to a predetermined potential. The exposure portion 7 exposes to light the outer circumferential surface of the photosensitive drum electrostatically charged by the charging portion to form an electrostatic latent image of a document image on the outer circumferential surface of the photosensitive drum. The developing portion feeds toner to the electrostatic latent image to develop it into a toner image. The four image forming portions 20 form toner images of different colors. After the toner image is primarily transferred to the outer circumferential surface of the intermediate transfer belt 31, the drum cleaning portion cleans the outer circumferential surface of the photosensitive drum by removing toner and other deposit on it. In this way, the image forming portion 20 forms an image (toner image) which will be transferred to the sheet S later.

The transfer portion 30 includes the intermediate transfer belt 31, primary transfer portions 32Y, 32C, 32M, and 32B, the secondary transfer portion 33, and a belt cleaning portion 34. The intermediate transfer belt 31 is arranged above the four image forming portions 20. The intermediate transfer belt 31 is supported so as to be rotatable in a predetermined direction (counterclockwise in FIG. 1). The intermediate transfer belt 31 is an endless intermediate transferring member to which the toner images formed on the outer circumferential surfaces of the photosensitive drums in the four image forming portions 20 are, while being sequentially overlaid on each other, primarily transferred. The four image forming portions 20 are arranged in what is called a tandem formation in which they are lined up in a row from upstream to downstream in the rotation direction of the intermediate transfer belt 31.

The primary transfer portions 32Y, 32C, 32M, and 32B are arranged above the image forming portions 20Y, 20C, 20M, and 20B for different colors with the intermediate transfer belt 31 in between. The secondary transfer portion 33 is arranged upstream of the fixing portion 8 with respect to the sheet conveyance direction of the sheet conveyance portion 6, downstream of the four image forming portions 20Y, 20C, 20M, and 20B with respect to the rotation direction of the intermediate transfer belt 31. The belt cleaning portion 34 is arranged upstream of the four image forming portions 20Y, 20C, 20M, and 20B with respect to the rotation direction of the intermediate transfer belt 31.

The primary transfer portion 32 transfers the toner image formed on the outer circumferential surface of the photosensitive drum to the intermediate transfer belt 31. In other words, the toner image is primarily transferred to the outer circumferential surface of the intermediate transfer belt 31 in the primary transfer portions 32Y, 32C, 32M, and 32B for different colors. As the intermediate transfer belt 31 rotates, the toner images in the four image forming portions 20 are sequentially overlaid on each other and transferred to the intermediate transfer belt 31 at a predetermined timing, so that a color toner image in which the toner images of four colors, namely yellow, cyan, magenta, and black, are overlaid on each other is formed on the outer circumferential surface of the intermediate transfer belt 31.

The color toner image on the outer circumferential surface of the intermediate transfer belt 31 is transferred, at a secondary transfer nip portion formed in the secondary transfer portion 33, to the sheet S fed synchronously from the sheet conveyance portion 6. After secondary transfer, the belt cleaning portion 34 cleans the outer circumferential surface of the intermediate transfer belt 31 by removing toner and other deposit on it. In this way, the transfer portion 30 transfers (records) the toner image formed on the outer circumferential surface of the photosensitive drum to the sheet S.

The fixing portion 8 is arranged above the secondary transfer portion 33. The fixing portion 8 heats and presses the sheet S having the toner image transferred to it and thereby fixes the toner image to the sheet S.

The sheet conveyance device 9 is arranged above the transfer portion 30, below the image reading portion 4. The sheet conveyance device 9 extends along the conveyance direction of the sheet S in the left-right, longitudinal direction in the image forming apparatus 1. The sheet S having the toner image fixed to it and having undergone printing is conveyed to the sheet conveyance device 9. When duplex printing is performed on the sheet S, the sheet conveyance device 9 switches the sheet S back to switch its conveyance direction.

The sheet conveyance device 9 also serves as a relay conveyance device for the sheet S with respect to a sheet post-processing device (not illustrated) that is arranged on the left side of the image forming apparatus 1 in FIG. 1 and connected to a side wall 2a of the image forming apparatus 1. That is, the sheet conveyance device 9 faces the sheet post-processing device in the sheet conveyance direction. The sheet conveyance device 9 conveys the printed sheet S through the sheet conveyance device 9 to the sheet post-processing device.

The control portion 10 includes a CPU, an image processing portion, a storage portion, and other electronic circuits and electronic components (none is illustrated). The CPU controls the operation of different components provided in the image forming apparatus 1 and performs processing related to the functions of the image forming apparatus 1 based on control programs and data stored in the storage portion. The sheet feeding portion 5, the sheet conveyance portion 6, the exposure portion 7, the image forming portion 20, the transfer portion 30, and the fixing portion 8 individually receive commands from the control portion 10 and cooperate to print on the sheet S. The storage portion is, for example, configured as a combination of a non-volatile storage device such as a program ROM (read-only memory) and a data ROM, and a volatile storage device such as a RAM (random-access memory).

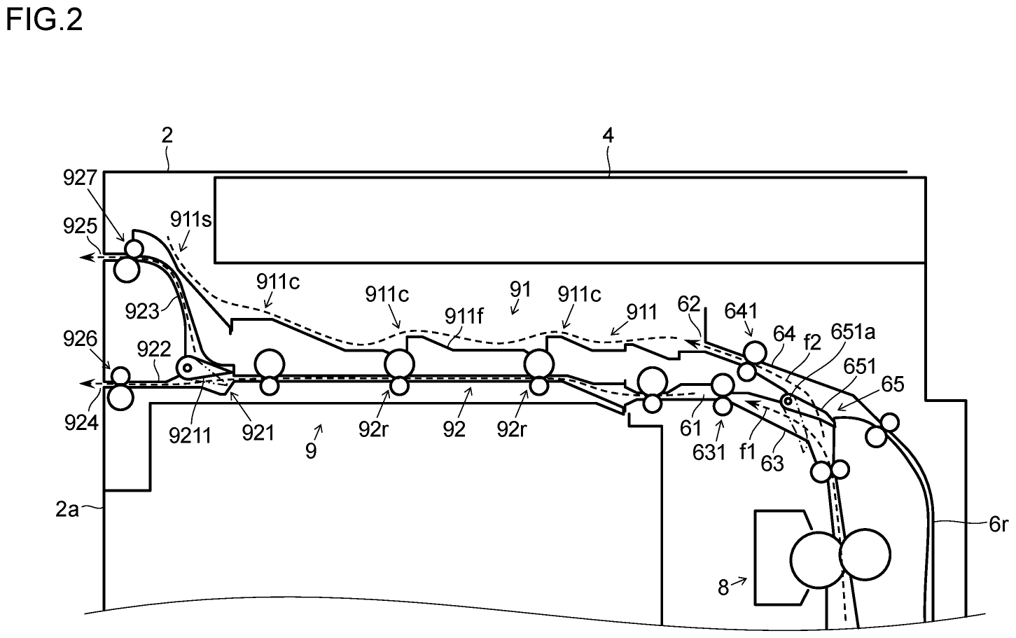

Next, the configuration of and around the sheet conveyance device 9 will be described with reference to FIG. 2. FIG. 2 is a sectional front view around the sheet conveyance device 9 in the image forming apparatus 1 in FIG. 1.

As shown in FIG. 2, the sheet conveyance portion 6 includes a sheet discharging portion 61, a sheet reversing portion 62, a first sheet conveyance passage 63, a second sheet conveyance passage 64, and a passage switching portion 65, all above the fixing portion 8, below the image reading portion 4.

The sheet discharging and reversing portions 61 and 62 are arranged opposite the sheet conveyance device 9. The sheet discharging and reversing portions 61 and 62 are arranged in parallel in the up-down direction. The sheet discharging portion 61 is arranged below the sheet reversing portion 62 and through it passes the sheet S being conveyed toward a relay conveyance portion 92, which will be described later, in the sheet conveyance device 9. The sheet reversing portion 62 is arranged above the sheet discharging portion 61 and through it passes the sheet S being conveyed toward a reversing conveyance portion 91, which will be described later, in the sheet conveyance device 9.

The first sheet conveyance passage 63 extends upward from the fixing portion 8 to the sheet discharging portion 61. Arrow f1 in FIG. 2 indicates the path along which the sheet S having passed through the fixing portion 8 travels toward the sheet discharging portion 61.

The first sheet conveyance passage 63 has a pair of first discharging rollers 631. The passage switching portion 65 is arranged on the first sheet conveyance passage 63, between the fixing portion 8 and the pair of first discharging rollers 631.

The pair of first discharging rollers 631 is arranged downstream of the first sheet conveyance passage 63. The pair of the first discharging roller pair 631 conveys the sheet S having passed through the passage switching portion 65 through the sheet discharging portion 61 toward the sheet conveyance device 9.

The second sheet conveyance device 64 branches from the passage switching portion 65 and extends upward to the sheet reversing portion 62. Arrow f2 in FIG. 2 indicates the path through which the sheet S having passed through the fixing portion 8 travels toward the sheet reversing portion 62. The second sheet conveyance passage 64 has a pair of second discharging rollers 641.

The pair of second discharging rollers 641 is arranged downstream of the second sheet conveyance passage 64. The pair of the second discharging roller pair 641 switches back the sheet S having passed through the passage switching portion 65 via the sheet reversing portion 62 in the sheet conveyance device 9.

Specifically, the pair of second discharging rollers 641, by rotating forward, makes the downstream end (leading end), in the conveyance direction, of the sheet S held in the nip jut out of the sheet reversing portion 62 into the sheet conveyance device 9. Then the pair of second discharging rollers 641 stops rotating before the upstream end (trailing end), in the conveyance direction, of the sheet S passes the nip portion, and then, by rotating backward, switches the conveyance direction of the sheet S to convey the sheet S toward the reversing conveyance passage 6r.

The passage switching portion 65 is arranged above the fixing portion 8, in a middle part of the first sheet conveyance passage 63. From the passage switching portion 65, the second sheet conveyance passage 64 branches from the first sheet conveyance passage 63. The passage switching portion 65 has a switching guide 651.

The switching guide 651 has a rotation shaft 651a. The rotation shaft 651a extends in the width direction (the front-rear direction with respect to the plane of FIG. 2) orthogonal to the conveyance direction of the sheet S. The switching guide 651 is swingable about the rotation shaft 651a and switches the conveyance direction of the sheet S to the first sheet conveyance passage 63 as indicated by a solid line in FIG. 2, or switches the conveyance direction of the sheet S to the second sheet conveyance passage 64 as indicated by a dash-dot-dot line in FIG. 2. Then the switching guide 651 feeds the sheet S having been switched back via the sheet reversing portion 62 in the sheet conveyance device 9 to the reversing conveyance passage 6r. The operation of the switching guide 651 is controlled by the control portion 10.

The sheet conveyance device 9 includes a reversing conveyance portion 91 and a relay conveyance portion 92.

The reversing conveyance portion 91 is arranged in a top part of the sheet conveyance device 9. The reversing conveyance portion 91 is arranged opposite the sheet reversing portion 62 in the sheet conveyance portion 6 with respect to the sheet conveyance direction. The reversing conveyance portion 91 extends along the conveyance direction of the sheet S in the left-right, longitudinal direction (horizontal direction) in the image forming apparatus 1. In the reversing conveyance portion 91, the pair of second discharging rollers 641 switches the sheet S back via the sheet reversing portion 62. That is, in the reversing conveyance portion 91, the sheet S is switched back by entering and exiting from it via the sheet reversing portion 62 in the horizontal direction, so that its conveyance direction is switched. The reversing conveyance portion 91 has a conveyance guide member 911.

The conveyance guide member 911 is provided in a lower part in the reversing conveyance portion 91. The conveyance guide member 911 extends downstream of the sheet reversing portion 62 in the conveyance direction of the sheet S to the side wall 2a (left side wall in FIGS. 1 and 2) of the image forming apparatus 1 to which the sheet post-processing device is connected. In other words, the conveyance guide 911 extends in the horizontal direction, downstream of the sheet reversing portion 62 in the conveyance direction of the sheet S. The conveyance guide member 911 has a sheet conveyance face 911f. The sheet conveyance face 911f faces the bottom face of the sheet S passing through the reversing conveyance portion 91. The sheet conveyance face 911f has a curved portion 911c.

The curved portion 911c is curved in the up-down direction as viewed from the width direction (the front-rear direction of the plane in FIG. 2) orthogonal to the conveyance direction (horizontal direction) of the sheet S. While in this embodiment the sheet conveyance face 911f has a plurality of curved portions 911c, it may have one or more curved portions 911c. The plurality of curved portions 911c of the conveyance guide member 911 form projections and depressions in the up-down direction on its top face. The sheet conveyance face 911f curves the sheet S along the curved portion 911c.

With the construction described above, the sheet S having advanced onto the top face of the conveyance guide member 911 is curved in the up-down direction by the curved portions 911c. That is, the reversing conveyance portion 91 can be configured to have a length smaller than the length of the sheet S with respect to the conveyance direction of the sheet S. Thus, the sheet conveyance device 9, despite having a size-reduced configuration, can secure a conveyance portion for switching back a longer sheet S.

The relay conveyance portion 92 is arranged in a lower part of the sheet conveyance device 9. In other words, the relay conveyance portion 92 is arranged below the conveyance guide member 911, in parallel with it. The relay conveyance portion 92 has a plurality of pairs of conveyance rollers 92r that convey the sheet S. The relay conveyance portion 92 extends from upstream to downstream of the reversing conveyance portion 91 with respect to the entering direction of the sheet S into the reversing conveyance portion 91. The relay conveyance portion 92 conveys downstream the sheet S discharged from the sheet discharging portion 61.

In other words, the relay conveyance portion 92 extends downstream of the sheet discharging portion 61 in the conveyance direction of the sheet S to the side wall 2a of the image forming apparatus 1 to which the sheet post-processing device is connected. The relay conveyance portion 92 conveys, with the plurality of pairs of conveyance rollers 92r, the sheet S having been discharged from the sheet discharging portion 61 and having entered the relay conveyance portion 92 to the sheet post-processing device. With this configuration, the sheet conveyance device 9, despite having a size-reduced configuration, can switch back a longer sheet S and in addition have a relay conveyance portion 92 that conveys the sheet S to the sheet post-processing device.

The relay conveyance portion 92 further includes a passage switching portion 921, a first sheet exit passage 922, a second sheet exit passage 923, a first sheet exit port 924, a second sheet exit port 925, a pair of first exit rollers 926, and a pair of second exit rollers 927.

The passage switching portion 921 is arranged in a downstream part of the relay conveyance portion 92 in the conveyance direction of the sheet S, near the side wall 2a of the image forming apparatus 1 to which the sheet post-processing device is connected. The first and second sheet exit passages 922 and 923 each branches from downstream of the passage switching portion 921 in the conveyance direction of the sheet S. The passage switching portion 921 has a switching guide 9211 that switches the sheet conveyance direction between the first and second sheet exit passages 922 and 923.

The first and second sheet exit passages 922 and 923 are arranged in parallel in the up-down direction. The first sheet exit passage 922 extends from the passage switching portion 921 to the side wall 2a in the horizontal direction. The first sheet exit port 924 is arranged at the downstream end of the first sheet exit passage 922 in the conveyance direction of the sheet S, near the side wall 2a, and is provided with the pair of first exit rollers 926. The second sheet exit passage 923 curves upward from the passage switching portion 921 and extends to the side wall 2a. The second sheet exit port 925 is arranged at the downstream end of the second sheet exit passage 923 in the conveyance direction of the sheet S, near the side wall 2a, and is provided with the pair of second exit rollers 927.

The second sheet exit passage 923 is arranged at approximately the same height as the reversing conveyance portion 91. The second sheet exit passage 923 is arranged on a downstream extension line along the entering direction of the sheet S into the reversing conveyance portion 91. The downstream end of the second sheet exit passage 923 in the conveyance direction of the sheet S, the second sheet exit port 925, and the pair of second exit rollers 927 are arranged in a side part of the image reading portion 4, above the lower end of the image reading portion 4.

The conveyance guide member 911 has an inclined portion 911s. The inclined portion 911s is arranged at the downstream end with respect to the entering direction of the sheet S into the conveyance guide member 911. The inclined portion 911s has such an inclination as to rise the farther away from the sheet reversing portion 62. That is, the inclined portion 911s is inclined upward. In other words, a part of the inclined portion 911s is arranged in a side part of the image reading portion 4, above the lower end of the image reading portion 4, and is located between the downstream end of the second sheet exit passage 923 in the conveyance direction of the sheet S and the image reading portion 4.

With the construction described above, at the downstream end with respect to the entering direction of the sheet S into the conveyance guide member 911, the conveyance guide member 911 can be curved sharply. Thus, it is possible to reduce the size of the sheet conveyance device 9 more effectively.

Above the reversing conveyance portion 91, the image reading portion 4 is arranged. Arranging a part of the conveyance guide member 911 (the inclined portion 911s) in a side part of the image reading portion 4 as in this embodiment allows effective use of the empty space in the image forming apparatus 1. That is, the image forming apparatus 1, despite having a size-reduced configuration, can secure a conveyance portion for switching back a longer sheet S.

The inclined portion 911s may be inclined downward in a configuration with no relay conveyance portion 92.

The length of the conveyance guide member 911 in the horizontal direction is smaller than the length of the longest sheet S conveyed to the reversing conveyance portion 91 in the conveyance direction. With this configuration, the length of the reversing conveyance portion 91 in the horizontal direction can be configured to be smaller than the length of the longest sheet S in the conveyance direction. Thus, the sheet conveyance device 9, despite having a size-reduced configuration, can secure a conveyance portion for switching back a longest sheet S.

While an embodiment of the present disclosure has been described above, it is not meant to limit the scope of the present disclosure, which can thus be carried out with any modifications made without departure from the spirit of the disclosure.

For example, in the above embodiment, the image forming apparatus 1 is assumed to be what is called a tandem-type image forming apparatus for color printing that forms images of multiple colors while sequentially overlaying them on each other, but this is not meant to be any limitation to a particular type of apparatus; the image forming apparatus may be a color-printing image forming apparatus other than of a tandem type, or may be an image forming apparatus for monochrome printing.

What is claimed is:

1. A sheet conveyance device comprising:
a reversing conveyance portion into and out of which a sheet from a sheet reversing portion in the horizontal direction travels to be switched back so that a conveyance direction of the sheet is switched; and
a conveyance guide member provided in the reversing conveyance portion, the conveyance guide member having a sheet conveyance face facing a bottom face of the sheet passing through the reversing conveyance portion,
wherein
the sheet conveyance face has one or more curved portions curved in the up-down direction as viewed from a width direction orthogonal to the conveyance direction of the sheet, the sheet conveyance face curving the sheet along the curved portion.

2. The sheet conveyance device according to claim 1, further comprising:
a relay conveyance portion arranged below the conveyance guide member in parallel therewith and extending from upstream to downstream of the reversing conveyance portion with respect to an entering direction of the sheet into the reversing conveyance portion, the relay conveyance portion conveying downstream the sheet discharged from a sheet discharging portion.

3. The sheet conveyance device according to claim 1, wherein
the conveyance guide member has an inclined portion at a downstream end with respect to the entering direction of the sheet into the reversing conveyance portion, the inclined portion being inclined upward or downward.

4. The sheet conveyance device according to claim 1, wherein
the conveyance guide member extends downstream of the sheet reversing portion in the conveyance direction of the sheet, and
a length of the conveyance guide member in a horizontal direction is smaller than a length of the longest sheet conveyed to the reversing conveyance portion in the conveyance direction.

5. An image forming apparatus comprising:
a sheet reversing portion;
a sheet discharge portion; and
the sheet conveyance device according to clam 1.

6. The image forming apparatus according to claim 5, comprising:
an image reading portion that is arranged above the reversing conveyance portion and that reads an image on a document.
